(19) United States
(12) Patent Application Publication
(10) Pub. No.: US 2008/0034173 A1
(43) Pub. Date: Feb. 7, 2008

(54) PORTABLE MEMORY ERASING DEVICE

(75) Inventor: Matthew Lavin, Raleigh, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/461,977

(22) Filed: Aug. 2, 2006

(51) Int. Cl. G06F 13/00; G06F 12/00

(52) U.S. Cl. 711/159; 711/112; 711/115

(57) ABSTRACT

An invention is disclosed for a portable memory erasing device that connects directly to one or more uninstalled computer “hard disk” memory storage drive(s) to provide the function of erasing all data stored on the drive without requiring use of a separate computer and/or extra hardware or software. The device can be transported for use in different locations, and it contains computer processing hardware running associated software capable of accessing and communicating with applicable drive storage formats and/or protocols in order to ensure that the accessed information is securely removed from the drive, and it allows the hard drive to be reusable after erasing.

### TECHNICAL FIELD

This invention relates to a portable memory erasing device that connects directly to a computer “hard disk” memory storage drive to provide the function of erasing data stored on the drive without requiring use of a separate computer and/or extra hardware or software.

### BACKGROUND

The current widespread use of computers has led to much business and personal information being stored in electronic form. A common means of storing such information is through use of computer “hard disk” memory storage drives located within an individual or distributed computer system and/or network. When a “hard drive” is installed within a computer its contents are relatively secure from data theft. However, sensitive and/or private information contained on an uninstalled or discarded hard drive can easily fall into the hands of an unauthorized user when the drive is removed through replacements and upgrades.

A common solution for this problem is the use of drive wiping/cleaning software, i.e., a computer program that erases information from a hard drive while it is still installed in a computer. However, the problem with such a solution is that it requires the hard drive to remain installed in the computer while its contents are being deleted, and it requires the use of extra software to accomplish this. Another problem with this solution is that a computer service technician or other user may be working in a remote location without the ability to install drive cleaning software while performing a repair or replacement. Other current drive cleaning methods such as those described in U.S. Pat. No. 6,570,727 and in U.S. Patent Application Publication Nos. 2005/0041319 & 2004/0051989 (the teachings of all of which are incorporated by reference as if fully set forth herein) disclose magnetic portable hard drive erasing devices, but such devices require complicated extra mechanical hardware for their operation. Also, the drive cleaning devices which use a magnetic field typically cause the hard drive to be unusable in the future, but this invention allows the hard drive to be reusable after erasing.

As a result, various computer hardware service organizations (along with other industries and users) requiring access to a simple method of removing sensitive information from a computer hard drive can benefit from this invention, which provides a portable memory erasing device that connects directly to a computer “hard disk” memory storage drive to provide the function of erasing (or “wiping”) all data stored on the drive without requiring use of a separate computer and/or extra hardware or software.

### SUMMARY OF THE INVENTION

This invention provides a device, method and system for using a portable memory erasing device that connects directly to one or more computer “hard disk” memory storage drive(s) to provide the function of erasing data stored on the drive without requiring use of a separate computer and/or extra hardware or software. The device can be transported for use in different locations, and it contains computer processing hardware running associated software capable of accessing and communicating with applicable drive storage formats and/or protocols to ensure that accessed information is securely removed from the drive, and it allows the hard drive to be reusable after erasing.

It is therefore an object of the present invention to overcome the disadvantages of the prior art by providing a device, method and system for using a portable memory erasing device that connects directly to one or more uninstalled computer “hard disk” memory storage drive(s) to provide the function of erasing all data stored on the drive without requiring use of a separate computer and/or extra hardware or software.

It is another object of the present invention to overcome the disadvantages of the prior art by providing a device, method and system for using a portable memory erasing device that contains computer processing hardware running associated software capable of accessing and communicating with applicable drive storage formats and/or protocols to ensure that accessed information is securely removed from the drive, and which allows the hard drive to be reusable after erasing.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is a diagram illustrating use of a portable memory erasing device that connects directly to a computer “hard disk” memory storage drive.

### DETAILED DESCRIPTION OF THE PREFERRED EMBODIMENTS

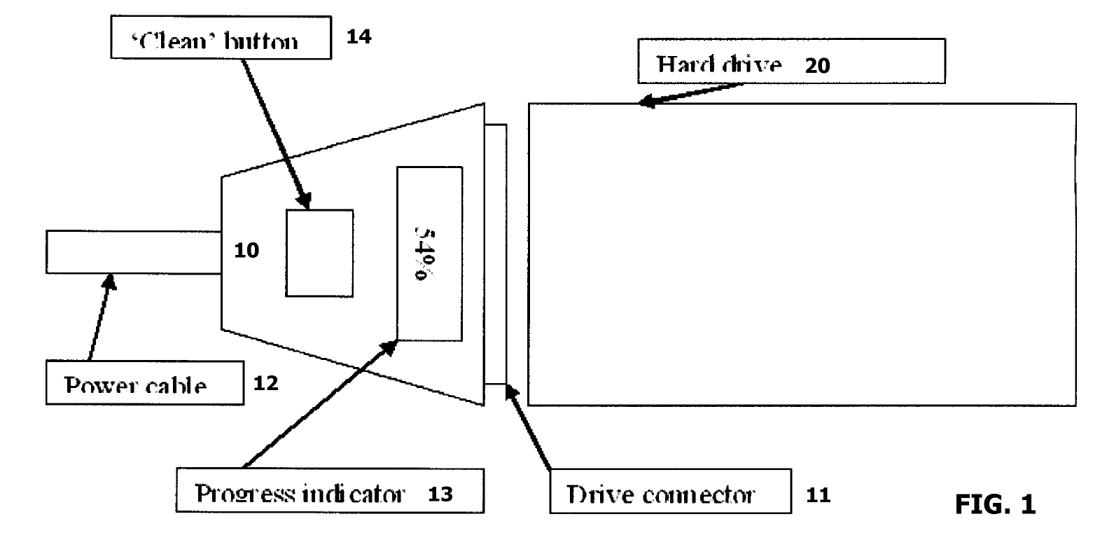

FIG. 1 is a diagram illustrating use of a portable memory erasing device 10 that connects directly to a computer “hard disk” memory storage drive 20 to provide the function of erasing (or “wiping”) data stored on the drive. The device can be attached in an independent (or “stand-alone”) manner to one or more uninstalled or removed computer hard drive(s) to delete sensitive and/or private information without requiring use of a separate computer and/or extra hardware or software. The device preferably accomplishes this by use of self-contained computer processing hardware (i.e., a microprocessor) running associated software (similar to conventional drive wiping/cleaning software such as “Disk Wiper” or “KillDisk”) that is capable of accessing and communicating with applicable drive storage formats and/or protocols (such as small computer system interface (SCSI) or advanced technology attachment (ATA/ATAPI) protocols) to ensure that all accessed information is quickly and securely removed from the hard drive. However, implementation of the device firmware/software would be different from such conventional software, since the device does not access the hard drive through an operating system but instead communicates with the hard drive using native protocols. Additionally, the device is preferably compact in size so that it can be transported for use in different locations, and also simple in operation to allow use by nontechnical person(s), and it allows the hard drive to be reusable after erasing.

FIG. 1 illustrates a preferred construction of portable memory storage erasing device 10: including at least one electrical drive connector 11 (such as a serial advanced technology attachment (SATA) or SCSI or universal serial bus (USB) or integrated drive electronics (IDE) connector) for attaching the device to one or more computer hard drive(s) 20; a power cable 12 for connecting electrical power to the device; a “progress indicator” screen 13 for providing an updated status on the extent of data deletion from a hard drive; and a “clean” button control 14 to be activated by a user for initiating data deletion. Use of the portable memory erasing device 10 involves attaching one or more computer hard drive(s) 20 each to a connector 11 while then activating the “clean” button 14 to initiate data deletion, and subsequently detaching the hard drive 20 from its connector 11 after the progress indicator 13 signals that device 10 is finished with the data deletion operation.

Many different variations of the portable memory storage erasing device are possible; including a device with multiple drive connectors so that more than one hard drive can be cleaned at the same time; as well as use of multiple different types of drive connectors, including attachments for laptop computer drives or external hard drives.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A portable memory erasing device configured with at least one electrical connection to one or more computer memory storage drives that is activated to erase data stored on the drive.

2. The portable memory erasing device of claim 1 further comprised of at least one computer processor running software and using a connection to access and communicate with one or more drive data storage formats or protocols to remove all accessed information from a drive.

3. The portable memory erasing device of claim 2 wherein at least one computer processor comprises a microprocessor running software within the device to remove information from a reusable computer memory storage drive.

4. The portable memory erasing device of claim 1 further comprised of:
(a). at least one electrical connector for attaching the device to one or more computer memory storage drives;
(b). a power cable for connecting electrical power to the device;
(c). a progress indicator for providing an updated status on the extent of data deletion from a drive; and
(d). a control activated by a user for initiating data deletion.

5. The portable memory erasing device of claim 4 wherein the device is independently attached to two or more uninstalled computer memory storage drives.

6. The portable memory erasing device of claim 4 wherein at least one electrical connector is selected from a group consisting of an SATA or SCSI or USB or IDE connector.

7. A computer system or network using a portable memory erasing device configured with at least one electrical connection to one or more computer memory storage drives that is activated to erase data stored on the drive.

8. A computer system or network using a portable memory erasing device of claim 7 further comprised of at least one computer processor running software and using a connection to access and communicate with one or more drive data storage formats or protocols to remove all accessed information from a drive.

9. A computer system or network using a portable memory erasing device of claim 8 wherein at least one computer processor comprises a microprocessor running software within the device to remove information from a reusable computer memory storage drive.

10. A computer system or network using a portable memory erasing device of claim 7 further comprised of:
(a). at least one electrical connector for attaching the device to one or more computer memory storage drives;
(b). a power cable for connecting electrical power to the device;
(c). a progress indicator for providing an updated status on the extent of data deletion from a drive; and
(d). a control activated by a user for initiating data deletion.

11. A computer system or network using a portable memory erasing device of claim 10 wherein the device is independently attached to two or more uninstalled computer memory storage drives.

12. A computer system or network using a portable memory erasing device of claim 10 wherein at least one electrical connector is selected from a group consisting of an SATA or SCSI or USB or IDE connector.

13. A method of using a portable memory erasing device for activating at least one electrical connection to one or more computer memory storage drives to erase data stored on the drive.

14. The method of claim 13 further comprised of running software on at least one computer processor and using a connection to access and communicate with one or more drive data storage formats or protocols to remove all accessed information from a drive.

15. The method of claim 14 wherein at least one computer processor comprises a microprocessor running software within the device to remove information from a reusable computer memory storage drive.

16. The method of claim 13 further comprised of using at least the following components for performing a procedure comprised of the following steps:
(a). using at least one electrical connector for attaching the device to one or more computer memory storage drives;
(b). using a power cable for connecting electrical power to the device;
(c). viewing a progress indicator for providing an updated status on the extent of data deletion from a drive; and
(d). activating a control for initiating data deletion.

17. The method of claim 16 wherein the device is independently attached to two or more uninstalled computer memory storage drives.

18. The method of claim 16 wherein at least one electrical connector is selected from a group consisting of an SATA or SCSI or USB or IDE connector.
